(19) United States
(12) Patent Application Publication
(10) Pub. No.: US 2015/0042905 A1
(43) Pub. Date: Feb. 12, 2015

(54) TOUCH PANEL WITH LINE-RESISTANCE INDUCTIVE ELECTRODE STRUCTURE

(71) Applicant: LIYITEC INCORPORATED, Gueishan Township (TW)

(72) Inventor: Shu-Chen HSU, Gueishan Township (TW)

(21) Appl. No.: 14/446,680

(22) Filed: Jul. 30, 2014

(30) Foreign Application Priority Data
Aug. 6, 2013 (TW) 102214675

(51) Int. Cl. G06F 3/041

(52) U.S. Cl. CPC G06F 3/041
USPC 349/12

(57) ABSTRACT

The present invention provides a touch panel with a line-resistance inductive electrode structure. The touch panel comprises a substrate, multiple first inductive electrode strings, multiple second inductive electrode strings, multiple first spacing lines, and multiple second spacing lines. The substrate comprises a surface. The first inductive electrode strings are formed on the surface of the substrate and are in a line-resistance type to increase the transmittance and brightness uniformity. The second inductive electrode strings are formed on the surface of the substrate are in a line-resistance type to increase the transmittance and brightness uniformity. The first/second spacing lines, which can improve the sensitivity of the first/second inductive electrode strings, are formed between the first/second inductive electrode strings.

### BACKGROUND OF THE INVENTION

1. Field of the Invention The present invention relates to a touch panel, especially to a touch panel with a line-resistance inductive electrode structure.

2. Description of the Prior Art(s)

A conventional capacitive touch panel comprises multiple strings of first inductive electrodes and multiple strings of second inductive electrodes, which are respectively formed on a surface of a substrate. The strings of the first inductive electrodes are set on the surface of the substrate and intersect the strings of the second inductive electrodes at an angle. An insulating layer is inserted between the strings of the first inductive electrodes and the strings of the second inductive electrodes, or multiple bridge structures are mounted in intersections of the strings of the first inductive electrodes and the strings of the second inductive electrodes to prevent inductive errors occurring from the strings of the first inductive electrodes stacked on or contacting the strings of the second inductive electrodes.

However, the strings of the first inductive electrodes and the strings of the second inductive electrodes made from a layer of Indium Tin Oxide (ITO) reduce a transmittance of the conventional capacitive touch panel. The insulating layer or the bridge structures also reduces the transmittance or blurs the conventional capacitive touch panel. Furthermore, under three primary colors (red, green, or blue) or sun light having 1200 to 1500 lumen, the brightness reduction of the conventional capacitive touch panel is further induced by the strings of the first inductive electrodes and the strings of the second inductive electrodes. Said problems need to be solved to meet the requirement of high transmittance and brightness uniformity in the field of touch panels.

To overcome the shortcomings, the present invention provides a touch panel to mitigate or obviate the aforementioned problems.

### SUMMARY OF THE INVENTION

The present invention provides a touch panel with a line-resistance inductive electrode structure to mitigate or obviate the reduction of transmittance or brightness uniformity caused from the use of ITO-made inductive electrode layers. The touch panel with a line-resistance inductive electrode structure comprises a substrate, multiple first inductive electrode strings, multiple second inductive electrode strings, multiple first spacing lines, and multiple second spacing lines.

The substrate comprises a surface.

The first inductive electrode strings are formed on the surface of the substrate. Each first inductive electrode string comprises multiple first inductive electrodes series-connected. Each first inductive electrode comprises an outer inductive line, multiple inner inductive lines, and a connecting line. The inner inductive lines of the first inductive electrode are surrounded by the outer inductive line of the first inductive electrode. The outer inductive line of the first inductive electrode and the inner inductive lines of the first inductive electrode form a first electrode pattern. The connecting line is attached to the outer inductive line of the first inductive electrode and is connected to the outer inductive line of the next neighboring first inductive electrode. The second inductive electrode strings are formed on the surface of the substrate. Each second inductive electrode string comprises multiple second inductive electrodes series-connected. Each second inductive electrode comprises an outer inductive line, multiple inner inductive lines, and multiple extended conducting lines. The inner inductive lines of the second inductive electrode are surrounded by the outer inductive line of the second inductive electrode. The outer inductive line of the second inductive electrode and the inner inductive lines of the second inductive electrode form a second electrode pattern. Any two neighboring extended conducting lines are separated by a gap and connect the outer inductive lines of the neighboring second inductive electrodes.

The first spacing lines are formed between the outer inductive lines of the first inductive electrodes and the neighboring outer inductive lines of the second inductive electrodes.

The second spacing lines are formed between the outer inductive lines of the second inductive electrodes and the neighboring outer inductive lines of the first inductive electrodes.

Other objectives, advantages and novel features of the invention will become more apparent from the following detailed description when taken in conjunction with the accompanying drawings.

### BRIEF DESCRIPTION OF THE DRAWINGS

FIG. 1 is a top view of a touch panel in accordance with Embodiment 1 of the present invention;

FIG. 2 is a partially enlarged perspective view of the touch panel in FIG. 1;

FIG. 3 is another partially enlarged perspective view of the touch panel in FIG. 1;

FIG. 4 is a partially enlarged exploded view of the touch panel in FIG. 1; and

FIG. 5 is a partially enlarged perspective view of a touch panel in accordance with Embodiment 2 of the present invention.

### DETAILED DESCRIPTION OF THE PREFERRED EMBODIMENTS

### Embodiment 1

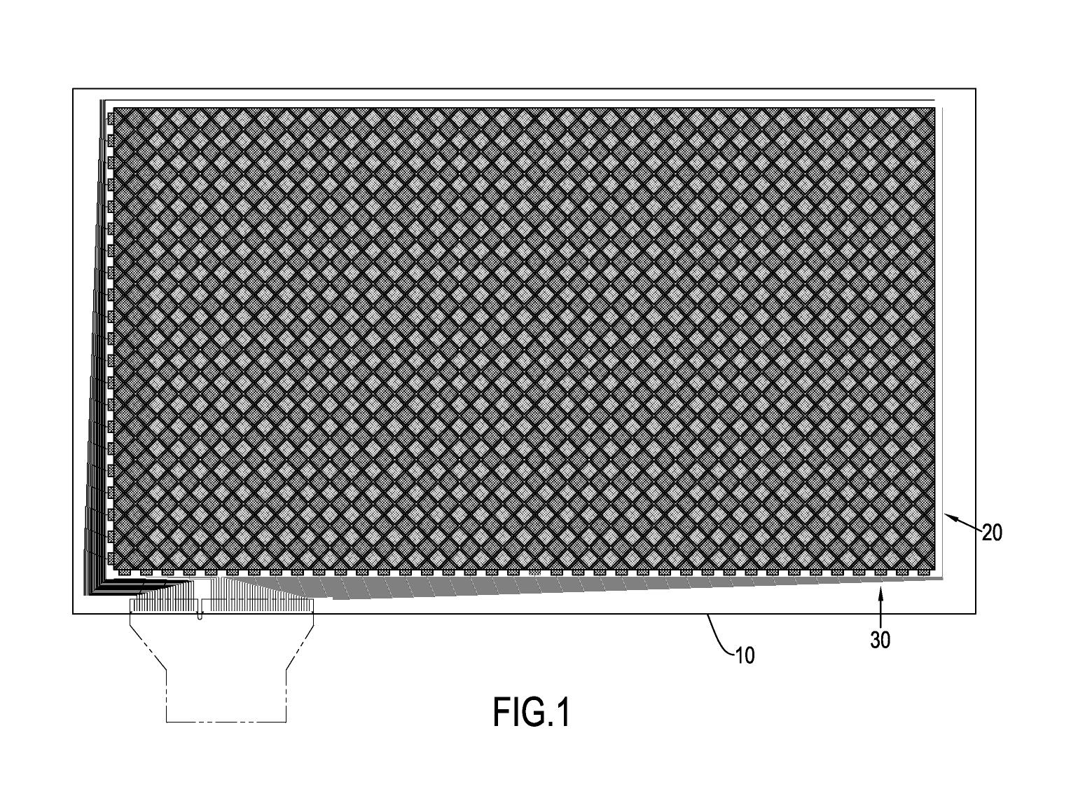

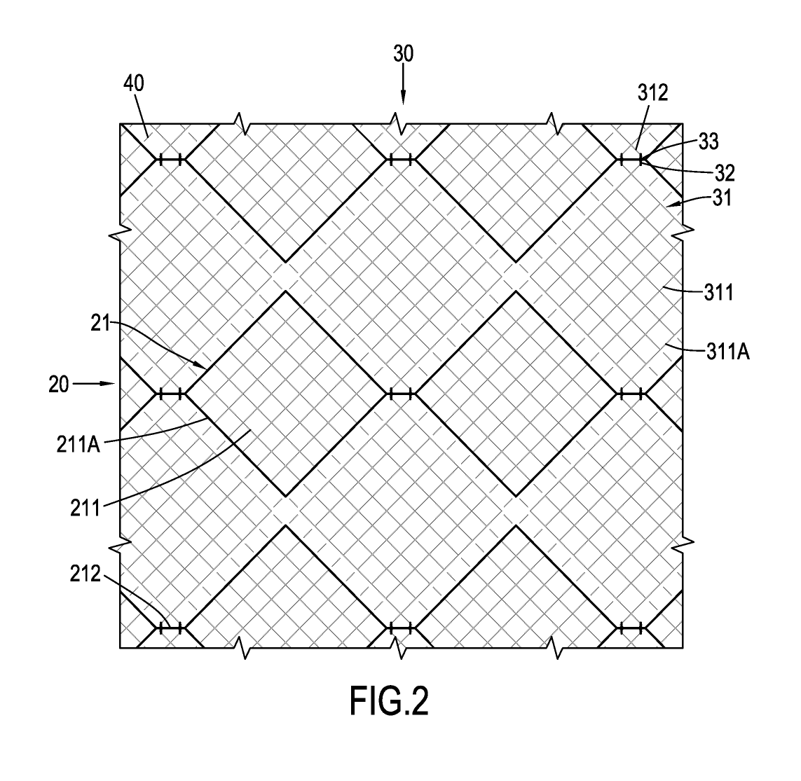

With reference to FIG. 1 and FIG. 2, a touch panel with a line-resistance inductive electrode structure comprises a substrate 10, a first electrode group, a second electrode group, and multiple spacing lines 40.

The substrate 10 comprises a surface.

The first electrode group is formed on the surface of the substrate and comprises multiple first inductive electrode strings 20. The first inductive electrode strings 20 are arranged abreast along a first direction. In Embodiment 1, the first direction is along the x-axis.

The second electrode group is formed on the surface of the substrate and intersects the first electrode group at a right angle. The second electrode group comprises multiple second inductive electrode strings 30. The second inductive electrode strings 30 are arranged abreast along a second direction. In Embodiment 1, the second direction is along the y-axis. In other words, the second direction intersects the first direction at a right angle.

The first inductive electrode strings 20 comprise multiple first inductive electrodes 21, which are set along the first direction. Each first inductive electrode 21 is consisted of multiple inner inductive lines 211, an outer inductive line 211A, and a connecting line 212.

The outer inductive line 211A and the inner inductive lines 211 form a first electrode pattern. The connecting line 212 is attached to the outer inductive line 211A and connects to the next neighboring outer inductive line 211A of the first inductive electrode 21 of the first inductive electrode string 20.

In Embodiment 1, the outer inductive line 211A surrounds the inner inductive lines 211 and has a shape of a rhombus. Each first inductive electrode 21 comprises twelve inner inductive lines 211, and each inner inductive line 211 comprises two ends. Six of the inner inductive lines 211 are arranged abreast and the ends of the six of the inner inductive lines 211 connect to the outer inductive line 211A. The other six of the inner inductive lines 211 are arranged abreast and intersect the six of the inner inductive lines 211. The ends of the other six of the inner inductive lines 211 connect to the outer inductive line 211A. That is to say, the first electrode pattern is a mesh pattern.

For further description of the present invention, the twelve inner inductive lines 211 are all arranged abreast and the ends of the inner inductive lines 211 connect to the outer inductive line 211A. That is to say, the first electrode pattern is a grid pattern.

The second inductive electrode strings 30 comprise multiple second inductive electrodes 31, multiple jumpers 32, and multiple insulating sheets 33. The second inductive electrodes 31 are set along the second direction. Each second inductive electrode 31 is consisted of multiple inner inductive lines 311 and an outer inductive line 311A.

The outer inductive line 311A and the inner inductive lines 311 form a second electrode pattern. In Embodiment 1, the outer inductive line 311A surrounds the inner inductive lines 311 and has a shape of a rhombus. Each second inductive electrode 31 comprises twelve inner inductive lines 311 and each inner inductive line 311 comprises two ends. Six of the inner inductive lines 311 are arranged abreast and the ends of the six of the inner inductive lines 311 connect to the outer inductive line 311A. The other six of the inner inductive lines 311 are arranged abreast and intersect the six of the inner inductive lines 311. The ends of the other six of the inner inductive lines 311 connect to the outer inductive line 311A. That is to say, the second electrode pattern is a mesh pattern.

For further description of the present invention, the twelve inner inductive lines 311 are all arranged abreast and the ends of the inner inductive lines 311 connect to the outer inductive line 311A. That is to say, the second electrode pattern is a grid pattern.

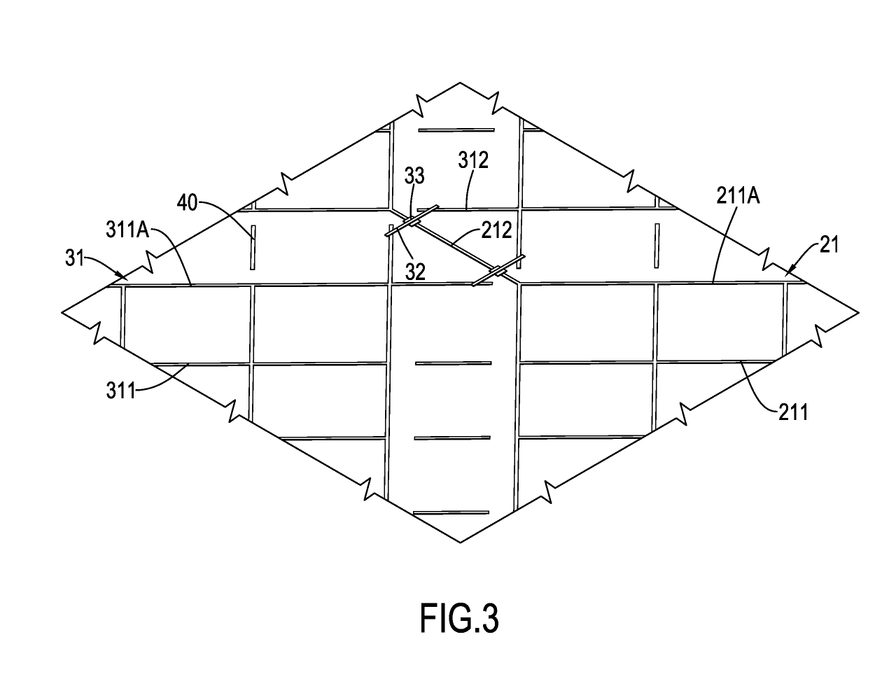

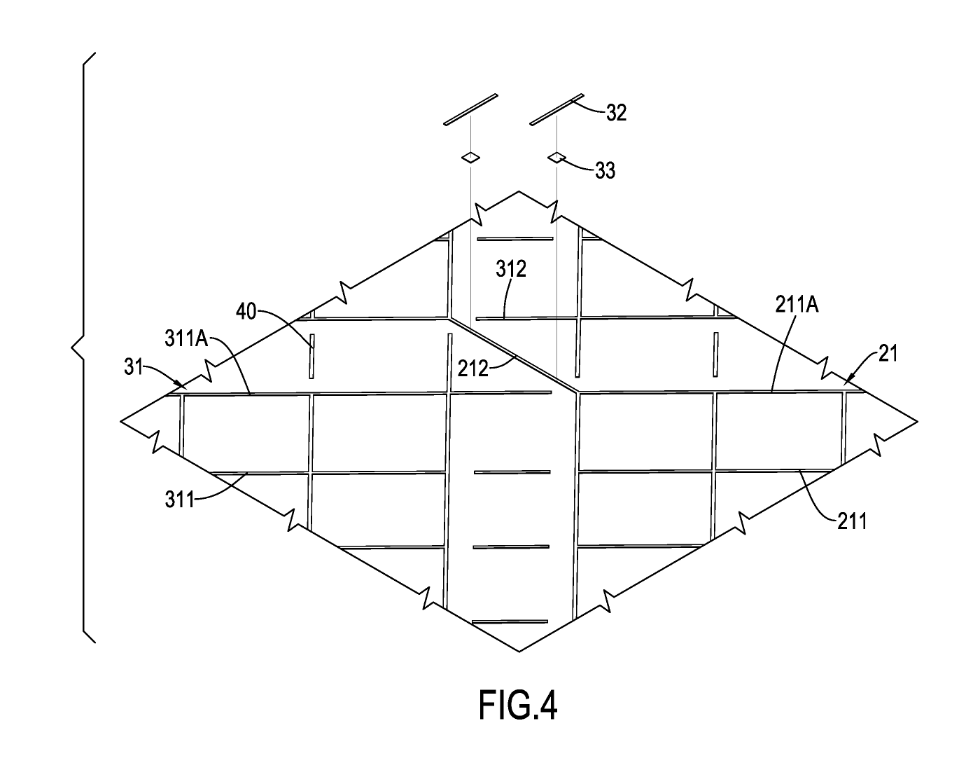

With reference to FIG. 3 and FIG. 4, two opposite ends of any two neighboring second inductive electrodes 31 respectively extend to form two extended conducting lines 312 with a gap between any two neighboring extended conducting lines 312. The extended conducting lines 312 are formed along a lengthwise direction of the outer inductive line 311A of the second inductive electrode 31 and disconnect from the outer inductive line 211A or from the connecting line 212 of the first inductive electrode 21. As shown in FIG. 3, for example but not as limitation, the extended conducting lines 312 intersect with one another into a bifurcation pattern. For further description of the present invention, the extended conducting lines 312 can be formed along the second direction and are parallel with one another.

The jumpers 32 connect to the extended conducting lines 312 of any two neighboring second inductive electrodes 31 and cross jump over the connecting line 212 of the first inductive electrode 21 at an angle.

The insulating sheets 33 are respectively set at each intersection of the connecting line 212 and the jumpers 32. The insulating sheets 33 each have a shape of a square. For further description of the present invention, the insulating sheets 33 are rectangles.

The spacing lines 40, which can improve the sensitivity of the first inductive electrodes 21 and the second inductive electrodes 31, are formed between each first inductive electrode 21 and the neighboring second inductive electrodes 31. The spacing lines 40 are at an angle to the outer inductive line 211A of the first inductive electrodes 21, but the spacing lines 40 do not connect to the outer inductive lines 211A of the first inductive electrodes 21. The spacing lines 40 are at an angle to the outer inductive lines 311A of the second inductive electrodes 31, but the spacing lines 40 do not connect to the outer inductive lines 311A of the second inductive electrodes 31.

### Embodiment 2

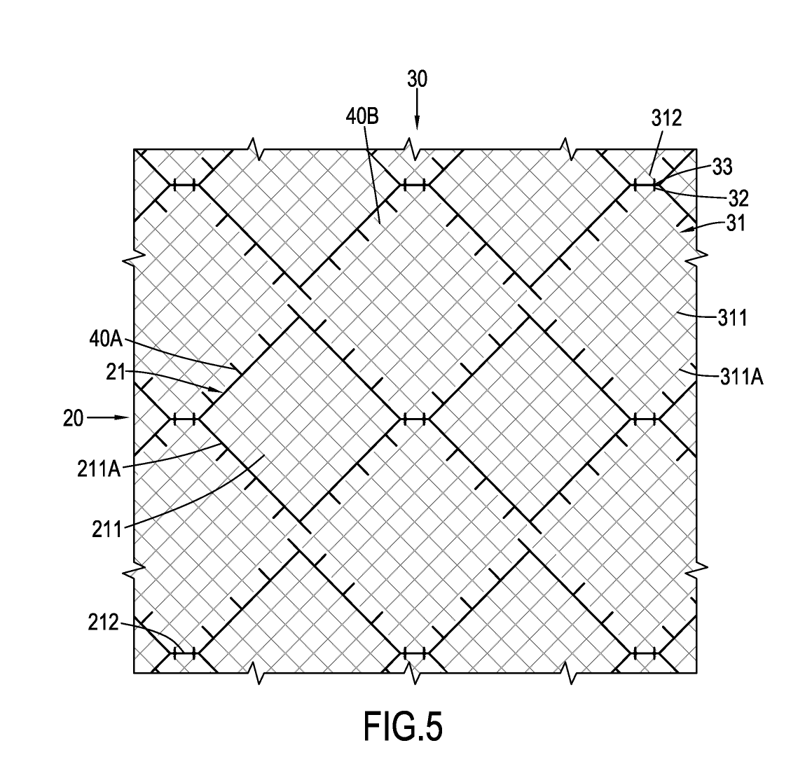

The touch panel with a line-resistance inductive electrode structure in Embodiment 2 is similar to the touch panel with a line-resistance inductive electrode structure of Embodiment 1. With reference to FIG. 5, the difference between the two embodiments is that the spacing lines of Embodiment 2 include multiple first spacing lines 40A and multiple second spacing lines 40B. The first spacing lines 40A are formed between each first inductive electrode 21 and the neighboring second inductive electrodes 31, and the first spacing lines 40A connect to the outer inductive lines 211A of the first inductive electrodes 21. The second spacing lines 40B are formed between each first inductive electrode 21 and the neighboring second inductive electrodes 31, and the second spacing lines 40B connect to the outer inductive lines 311A of the second inductive electrodes 31. The first spacing lines 40A, which connect to the outer inductive lines 211A of the first inductive electrodes 21, are arranged alternately with the second spacing lines 40B of the neighboring outer inductive line 311A of the second inductive electrodes 31.

In accordance with Embodiment 1 and Embodiment 2, the inner inductive lines 211 of the first inductive electrodes 21 form a mesh pattern, the inner inductive lines 311 of the second inductive electrodes 31 also form a mesh pattern, the extended conducting lines 312 of the second inductive electrode 31 have the gap between any two neighboring extended conducting lines, the jumpers 32 connect to the extended conducting lines 312 of any two neighboring second inductive electrodes 31 and cross jump over the connecting line 212 of the first inductive electrode 21, the insulating sheets 33 are respectively set at intersections of the connecting line 212 and the jumpers 32, and the first spacing lines 40A, which connect to the outer inductive lines 211A of the first inductive electrodes 21, are arranged alternately with the second spacing lines 40B of the neighboring outer inductive line 311A of the second inductive electrodes 31, thereby increasing the transmittance of the touch panel with a line-resistance inductive electrode structure and preventing light leakage of the touch panel with a line-resistance inductive electrode structure. Beside, the transmittance of the touch panel with a line-resistance inductive electrode structure can be further improved by reducing the area of the insulating sheets 33. Furthermore, the first inductive electrodes 21, the second inductive electrodes 31, and the extended conducting lines 312 are formed in line-resistance type, which can be printed on the surface of the substrate 10 by a one-step printing process, so as to reduce the resistance, capacitance, and parasitic capacitance between the first inductive electrodes 21 and the second inductive electrodes 31, and to increase the transmittance and brightness uniformity of the touch panel with a line-resistance inductive electrode structure.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A touch panel with a line-resistance inductive electrode structure comprising:
a substrate comprising a surface;
multiple first inductive electrode strings formed on the surface of the substrate, each first inductive electrode string comprising
multiple first inductive electrodes series-connected, each first inductive electrode comprising
an outer inductive line;
multiple inner inductive lines are surrounded by the outer inductive line of the first inductive electrode, the inner inductive lines of the first inductive electrode and the outer inductive line of the first inductive electrode forming a first electrode pattern; and
a connecting line attached to the outer inductive line of the first inductive electrode and connecting to the outer inductive line of the next neighboring first inductive electrode;
multiple second inductive electrode strings formed on the surface of the substrate, each second inductive electrode string comprising
multiple second inductive electrodes series-connected, each second inductive electrode comprising
an outer inductive line;
multiple inner inductive lines are surrounded by the outer inductive line of the second inductive electrode, the inner inductive lines of the second inductive electrode and the outer inductive line of the second inductive electrode forming a second electrode pattern; and
multiple extended conducting lines, any two neighboring extended conducting lines having a gap between each other and connecting the outer inductive lines of the neighboring second inductive electrodes; and
multiple first spacing lines formed between the outer inductive lines of the first inductive electrodes and the neighboring outer inductive lines of the second inductive electrodes;
multiple second spacing lines formed between the outer inductive lines of the second inductive electrodes and the neighboring outer inductive lines of the first inductive electrodes.

2. The touch panel with a line-resistance inductive electrode structure as claimed in claim 1, wherein the outer inductive line of the first inductive electrode has a shape of a rhombus;
each inner inductive line of the first inductive electrode comprises two ends, half of the inner inductive lines of the first inductive electrode are arranged abreast and the ends of the half of the inner inductive lines of the first inductive electrode connect to the outer inductive line of the first inductive electrode; and
the other half of the inner inductive lines of the first inductive electrode are arranged abreast and intersect the half of the inner inductive lines of the first inductive electrode, and the ends of the other half of the inner inductive lines of the first inductive electrode connect to the outer inductive line of the first inductive electrode.

3. The touch panel with a line-resistance inductive electrode structure as claimed in claim 2, wherein the outer inductive line of the second inductive electrode has a shape of a rhombus;
each inner inductive line of the second inductive electrode comprises two ends, half of the inner inductive lines of the second inductive electrode are arranged abreast and the ends of the half of the inner inductive lines of the second inductive electrode connect to the outer inductive line of the second inductive electrode; and
the other half of the inner inductive lines of the second inductive electrode are arranged abreast and intersect the half of the inner inductive lines of the second inductive electrode, and the ends of the other half of the inner inductive lines of the second inductive electrode connect to the outer inductive line of the second inductive electrode.

4. The touch panel with a line-resistance inductive electrode structure as claimed in claim 3, wherein the first electrode pattern and the second electrode pattern are mesh patterns.

5. The touch panel with a line-resistance inductive electrode structure as claimed in claim 1, wherein each second inductive electrode comprises two extended conducting lines formed along a lengthwise direction of the outer inductive line of the second inductive electrode without connecting to the outer inductive line or the connecting line of the first inductive electrode.

6. The touch panel with a line-resistance inductive electrode structure as claimed in claim 1, wherein each second inductive electrode comprises two extended conducting lines formed along a direction of the second inductive electrode string and being parallel to each other without connecting to the outer inductive line or the connecting line of the first inductive electrode.

7. The touch panel with a line-resistance inductive electrode structure as claimed in claim 1, wherein the first spacing lines connect to the outer inductive lines of the first inductive electrodes;
the second spacing lines connect to the outer inductive lines of the second inductive electrodes; and
the first spacing lines and the second spacing lines are alternately arranged.

8. The touch panel with a line-resistance inductive electrode structure as claimed in claim 5, wherein the first spacing lines connect to the outer inductive lines of the first inductive electrodes;
the second spacing lines connect to the outer inductive lines of the second inductive electrodes; and
the first spacing lines and the second spacing lines are alternately arranged.

9. The touch panel with a line-resistance inductive electrode structure as claimed in claim 6, wherein the first spacing lines connect to the outer inductive lines of the first inductive electrodes;
the second spacing lines connect to the outer inductive lines of the second inductive electrodes; and
the first spacing lines and the second spacing lines are alternately arranged.

10. The touch panel with a line-resistance inductive electrode structure as claimed in claim 1, wherein the first spacing lines disconnect from the outer inductive lines of the first inductive electrodes and the outer inductive lines of the second inductive electrodes;
the second spacing lines disconnect from the outer inductive lines of the first inductive electrodes and the outer inductive lines of the second inductive electrodes.

11. The touch panel with a line-resistance inductive electrode structure as claimed in claim 5, wherein the first spacing lines disconnect from the outer inductive lines of the first inductive electrodes and the outer inductive lines of the second inductive electrodes;
the second spacing lines disconnect from the outer inductive lines of the first inductive electrodes and the outer inductive lines of the second inductive electrodes.

12. The touch panel with a line-resistance inductive electrode structure as claimed in claim 6, wherein the first spacing lines disconnect from the outer inductive lines of the first inductive electrodes and the outer inductive lines of the second inductive electrodes;
the second spacing lines disconnect from the outer inductive lines of the first inductive electrodes and the outer inductive lines of the second inductive electrodes.
